(19) United States
(12) Patent Application Publication
(10) Pub. No.: US 2018/0363259 A1
(43) Pub. Date: Dec. 20, 2018

(54) BARRIER SYSTEM AND METHOD OF USE THEREOF

(71) Applicant: Highway Care Limited, Herefordshire (GB)

(72) Inventor: Adrian Bullock, Herefordshire (GB)

(21) Appl. No.: 16/008,887

(22) Filed: Jun. 14, 2018

Related U.S. Application Data
(60) Provisional application No. 62/521,902, filed on Jun. 19, 2017.

(51) Int. Cl. E01F 15/04

(52) U.S. Cl. CPC E01F 15/0423; E01F 15/0461; F16B 12/125; E01F 15/0484; E01F 15/0476

(57) ABSTRACT

A barrier system is provided including a plurality of barrier members arranged in an end to end manner to form an elongate barrier structure. A first end barrier member is located at a first end of the elongate barrier structure and a second end barrier member is located at a second end of the elongate barrier structure. Each of the first and second end barrier members have base anchor means provided or associated with at least an outermost end thereof to anchor a base of the first and second end barrier members to a surface on which the barrier system is to be located in use. A pair of barrier members consisting of two adjacent barrier members, which are not the first and second end barrier members but which are adjacent to each of the same, are provided with channel means located on, at or adjacent at a top thereof.

### CROSS-REFERENCE TO RELATED APPLICATION

This application claims the benefit of U.S. Provisional Patent Application Ser. No. 62/521,902, filed Jun. 19, 2017.

### BACKGROUND OF THE INVENTION

### 1. Field of the Invention

This application relates to a barrier system and to a method of use thereof.

### 2. Description of the Related Art

Although the following description refers almost exclusively to a barrier system routinely used to prevent one or more vehicles from leaving a road in the event of an accident or loss of control of a driver of a vehicle, it will be appreciated by persons skilled in the art that the barrier system of the present invention can be any type of barrier that prevents, or at least hinders, the movement of one or more persons, animals and/or objects from one side of the barrier to an opposite side of the barrier in use.

It is known to provide a barrier system on one or more sides of a road to prevent a vehicle from leaving the road and/or moving onto an opposite carriageway or other lane defined in the road in use. An example of a known barrier system is shown in FIG. 1a, and comprises a plurality of barrier members joined together in an end to end manner to create an elongate barrier structure 2. At each end of the barrier structure there is provided an end barrier member 4, 6 having an anchor tray 8 joined to the same. The anchor tray 8 is joined to a free end of each of the barrier members 4, 6 adjacent a base thereof. The anchor tray 8 is shown in more detail in FIG. 2a and comprises a base 10 which extends outwardly from end wall 12 of barrier member 4. Two opposing upstanding side walls 14, 16 and an upstanding end wall 18 protrude upwardly from the peripheral edges of base 10. The upstanding end wall 18 is opposite to end wall 12 of the barrier member 4. Four anchor apertures 20 are defined in base 10 of anchor tray 8 at spaced apart intervals for the location of four anchor bolts 22 therethrough in use. The anchor bolts 22 are used to bolt the anchor tray 8, and thus the barrier member 4 to a surface or carriageway in use. An end cover (not shown) is typically located over the anchor tray 8 in use and is of the same height of the barrier member 4. The end cover can be attached to the end wall 12 of the barrier member 4 using protrusions provided on the cover which locate in the slots 3 on the end wall 12.

In addition, to anchoring the barrier structure in FIG. 1a at the extreme or free ends, a four point anchor plate 24 is also provided at the base at the opposite end of the end barrier members 4, 6 that have the base anchor trays 8 joined to the same. This end is typically referred to as the first inboard bolted joint 35 as it is where the end barrier member is joined to an adjacent barrier member using one or more joining plates, nuts and bolts 38 on the side walls of the adjacent barrier members. The four point anchor plate 24 is shown in more detail in FIG. 2b and comprises a base plate 26 that is wider than the width of the barrier member 4 at the base thereof such that a section 26′ and 26″ of the base plate 26 protrudes outwardly from each side wall 28, 30 of the barrier member 4 respectively. Each outwardly protruding section 26′, 26″ is provided with two spaced apart anchor apertures 32 for the location of anchor bolts 34 therethrough in use. The anchor plate 24 is located on a surface on which the barrier structure 2 is to be located in use and is placed centrally between the joint 35 of barrier member 4 with an adjacent barrier member 36. The two adjacent barrier members 4, 36 can be joined together with any suitable means, such as joining bolts 38 and/or the like. In the center of the anchor plate 24 are two upstanding rib members 39, 41. A detachable pin member 43 is removably located through apertures defined in the rib members 39, 41 to allow the anchor plate 24 to be joined to joining plates located internally of the barrier member in use.

It is to be noted that although barrier members 4 and 36 are described as separate barrier members, they are often delivered on site as a single combined barrier structure or pair.

The above described barrier member system is a standard system and has a deflection of approximately 1.5 m in crash testing when an elongate barrier system of 72 m in length is impacted by a vehicle in the center of the barrier system.

A further example of a known barrier system 100 is shown in FIG. 1b and provides a low deflection barrier system. Thus, in similar crash test conditions as the barrier system in FIG. 1a, the barrier system 100 in FIG. 1b has a deflection of approximately 0.89 m. The barrier system 100 uses the same end anchor arrangements shown in FIG. 1a, FIG. 2a-2b of the end anchor tray 8 and the four point anchor plate 24 at the first inboard bolted joint 35. However, in addition, system 100 is anchored every 12 meters along the length of the system via a two point anchor plate 102 provided at the base of the barrier system at the join between two adjacent barrier members that is not a bolted joint but which is a mortise and tenon joint 37. The mortise and tenon joint typically includes a male mortise and tenon connection joined to a female mortise and tenon connection. The mortise and tenon joint 37 is at the mid point between two inboard bolted joints 35. The two point anchor plate 102 is shown in more detail in FIG. 2c. The anchor plate 102 comprises a base plate 104 that is wider than the base width of the barrier member 36 such that a section 104′, 104″ protrudes outwardly from each side wall 28, 30 of the barrier member 36 respectively. Each outwardly protruding section 104′, 104″ is provided with an anchor aperture 106 for the location of an anchor bolt 108 therethrough in use. The anchor plate 104 is located on a surface on which the barrier structure 100 is to be located in use. Joining sections 110 are provided on the anchor plate 102 adjacent each protruding section 104′ 104″ and a spaced distance apart from the opposing free ends of anchor plate 104. These joining sections 110 are located underneath or in the internal cavity of the barrier member 36 in use and have joining apertures 112 defined thereon for the location of joining bolts 114 in use. The joining bolts 114 join the anchor plate 104 to a base flange or fixing plate located at the end of the barrier member 36 located between the opposing side walls 28, 30 of the barrier member 36. The two point anchor plates 102 are located at each mortise and tenon joint in the system such that the gap between adjacent two point anchor plates 102 is 12 meters.

A yet further known example of a barrier system 200 is shown in FIG. 1c and is the most rigid of the barrier systems shown in FIGS. 1a-1c and provides a minimum deflection system. In similar crash test conditions as the barrier systems in FIGS. 1a and 1b, the barrier system 200 in FIG. 1c has a deflection of approximately 0.076 m. The barrier system 200 is similar to barrier system 100 but, in addition to the two point anchor plates 102, it uses a further two point anchor plate 202 at all the inboard bolted joints 35 between adjacent barrier members 36′. Anchor plate 202 is shown in more detail in FIG. 2d and is similar to anchor plate 102 but an upstanding L-shaped member 204 is joined to the joining sections 110 on anchor plate 104. More particularly, member 204 includes a base portion 206 which is joined to joining sections 110 by bolts 114 and an upstanding portion 208 which is joined to an end wall of the barrier member 36′ abutting adjacent barrier member 36′ via nuts and bolts 210. The end walls of the barrier members 36′ are located internally of the barrier structure 200 when assembled. Anchor plates 202 are provided at the inboard bolted joints which are 12 meters apart, thereby providing two anchor points 102 or 202 every 6 meters along the barrier system.

In addition to the increased anchoring at the base of the barrier system, barrier system 200 includes a T-top 212 that is located on a top surface 214 of the barrier members 36, 36′ etc between the end barrier members 4, 6. The T-top is provided to contain a vehicle impacting with the same (i.e. prevents the vehicle from riding up the side of the barrier member and going over the top of the barrier member). The T-top 212 includes U-shaped members 214 that are each of a greater width than the width of the top surface 214 of the barrier member on which they are located. Thus, each T-top member 214 comprises a base wall 216 and two opposing side walls 218 to define a channel therebetween. The base wall 216 protrudes outwardly on each side of the top surface of the barrier member to form a shoulder portion which helps to prevent the vehicle from riding up the barrier member on impact of the vehicle with a barrier member. The end edges of each member 214 are joined to the end edges of an adjacent member 214 to form an elongate channel. A short sloped end T-top member 220 is provided on barrier members 4, 6 at the ends of the barrier system. The short sloped T-top member is less than half the top surface of the barrier member 4, 6 on which it is located and is provided from an end of the barrier member opposite to end wall 12 of the barrier member.

All of the abovementioned barrier systems shown in FIGS. 1a-1c meet the USA standard NCHRP350 (National Cooperative Highway Research Program 350). However, a new safety standard has been introduced in the USA called the Mash Standard (Manual of Assessing Safety Hardware), which requires barrier systems to be crash tested using larger vehicles having a higher center of gravity. The barrier systems also have to comply to a crash test called the Critical Impact Point Test (CIPT), wherein a vehicle is arranged to impact the barrier system at a point nearer one of its ends rather than centrally. A problem with the barrier system 2 is that it fails the critical impact test for a large vehicle under the MASH standard as the vehicle rides up the side of the barrier members and goes over the top of the barrier system. However, a problem with the barrier system 200 which passes the critical impact test under the MASH standard is that the barrier system is very heavy and expensive to produce as a result of all the additional components required, such as the extra anchor points and the T-top.

It is therefore an aim of the present invention to provide a barrier system that overcomes the abovementioned problem.

It is a further aim of the present invention to provide a method of using a barrier system that overcomes the abovementioned problem.

### SUMMARY OF THE INVENTION

According to a first aspect of the present invention there is provided a barrier system, said barrier system including a plurality of barrier members arranged in an end to end manner to form an elongate barrier structure, a first end barrier member located at a first end of the elongate barrier structure and a second end barrier member located at a second end of the elongate barrier structure, each of the first and second end barrier members having base anchor means provided on associated with at least an outermost end thereof to anchor a base of the first and second end barrier members to a surface on which the barrier system is to be located in use, and wherein a pair of barrier members consisting of two adjacent barrier members, which are not the first and second end barrier members but which are adjacent to each of the same, are provided with channel means located on or at a top thereof, and at least one barrier member adjacent said barrier member pairs is not provided with channel means on or at a top thereof.

Thus, in accordance with the present invention, there is provided a barrier system that provides base anchor means at at least the outermost ends of the system or elongate structure, and channel means or member(s) that are provided on, at or adjacent a top of pairs of barrier members adjacent to the end barrier members of the barrier system. This arrangement is sufficient to prevent large vehicles from riding up the side walls of the barrier following an impact of the vehicle with the barrier system, and which has a reduced number of components sufficient to reduce the cost of providing the system and to reduce the weight of the system.

Preferably the top of the barrier member pairs which as the channel means provided on, at or adjacent thereto is on an opposite surface to the base of the barrier member provided with the base anchor means.

Preferably the outermost ends of the end barrier members are at the extreme ends of the barrier structure or system.

Preferably the pair of the barrier members adjacent the end barrier members are directly adjacent the end barrier members.

Preferably the base anchor means is any mechanism that allows a base of the barrier to be anchored to a surface on which the barrier system is to be located in use.

Preferably the channel means is any member having a channel defined therein.

In one embodiment the barrier system, in terms of channel means provided on or at a top of a barrier member, consists only of the channel means provided on each pair of barrier members immediately or directly adjacent the first and second end barrier members. Thus, in this embodiment, no other channel means are provided on, adjacent or at a top of any other barrier member of the system or barrier structure, other than on the two pairs of barrier members.

In one embodiment the barrier system, in terms of channel means provided on or at a top of a barrier member, consists of the channel means provided on each pair of barrier members immediately or directly adjacent the first and second end barrier members, plus one further pair of barrier members of the system having channel means provided on or at a top thereof only. Thus, in this embodiment only three pairs of barrier members have channel means provided on or at a top thereof in the system or barrier structure.

Preferably the one further pair of barrier members of the system is provided centrally or substantially centrally of the barrier system or structure.

Further preferably the one further pair of barrier members of the system is provided a spaced distance apart from each pair of barrier members immediately or directly adjacent the end barrier members.

In one embodiment the barrier system, in terms of channel means provided on or at a top of a barrier member, consists of the channel means provided on the two pairs of barrier members adjacent the first and second end barrier members, plus at least one further pair of barrier members of the system having channel means provided on or at a top thereof, and with at least one barrier member adjacent the barrier member pairs having the channel means provided thereon being free from or not having the channel provided thereon. In this embodiment there is a gap of at least one barrier member without channel means provided on or at a top thereof between barrier member pairs having channel means provided on or at a top thereof.

Thus, in one example, the barrier system may include a plurality of barrier member pairs having channel means provided on or associated with a top thereof, with at least one barrier member located between said barrier member pairs which do not have channel means provided on or associated with the same.

In one embodiment each pair of barrier members having channel means provided on or associated with a top thereof has a barrier member directly adjacent both ends of the same which do not have channel means provided thereon.

In one embodiment a join between each of the first and second end barrier members and an adjacent barrier member is provided with or is associated with further or second base anchor means to anchor a base of the barrier member(s) to a surface on which the barrier system is to be located in use.

Preferably the join between each of the first and second end barrier members and an adjacent barrier member is known as a first inboard bolted joint.

Preferably the join or first inboard joint is provided at the intersection of the ends of the adjacent barrier members.

Preferably the join or first inboard bolted joint between each of the first and second end barrier members and an adjacent barrier member is joined by one or more joining members or joining plates.

Preferably the one or more joining members or joining plates are located internally of the barrier structure, although they could be located externally if required.

Preferably the joining member or joining plates are of such shape, size and/or design to allow the ends of the adjacent barrier members to be joined together in use.

In one embodiment each barrier member of the system, at least between the first and second end barrier members, consists of a first connection end and a second connection end. The first and second connection ends are provided with suitable connection means or mechanism to allow connection to an adjacent barrier member in use.

Preferably the first and second connection ends and/or connection means or mechanism are different.

In one embodiment, the first connection end or first connection means or mechanism comprises a mortise and tenon arrangement or connection, such as a female mortise and tenon connection, and the second end or second connection means is a male mortise and tenon. Thus, for example, a male mortise and tenon connection provided at one end of a barrier member is connectable to a female mortise and tenon connection provided at an end of an adjacent barrier member.

In one embodiment the second connection end or second connection means or mechanism comprises the joining member, joining plate and/or a bolted joint.

In one embodiment the second connection end or second connection means or mechanism comprises a male or female mortise and tenon connection.

In one embodiment barrier members are provided in lengths of two barrier members or pairs joined in the middle by a joining member, joining plate and/or a bolted joint and having first and second connection means provided at the outermost ends of the two barrier member length respectively. In this arrangement, the first and second connection means only need to be connected to adjacent barrier members or adjacent lengths of two barrier members on site at which the barrier system is to be located in use.

In one embodiment barrier members are provided in lengths of two barrier members joined in the middle by a first and/or second connection end or means.

In one embodiment, only the first and second end barrier members have base anchor means provided on or associated with the same.

Preferably the barrier members that are adjacent each of the first and second end barrier members respectively may have the base anchor means provided with the first and second end barrier members provided on or associated with the same.

In one embodiment, the barrier members of the system or structure, other than the first and second end barrier members and the immediately adjacent barrier members to the same, do not have base anchor means provided on or associated with the same.

Preferably each of the first and second end barrier members have a free end that is not joined to an adjacent barrier member and a joined end that is joined to an adjacent barrier member.

Preferably the free end of the first and second end barrier members has first base anchor means or mechanism associated with the same.

Preferably the joined end of the first and second end barrier members has the further or second base anchor means or mechanism associated with the same.

In one embodiment the first base anchor means includes a tray member having a base wall and one or more upstanding side walls associated with the base wall.

Preferably the base wall of the tray member is arranged to be flush or substantially flush with a base of the end barrier member in use.

Preferably the base wall of the tray member is arranged to be located directly or indirectly on the surface or same surface that the base of at least the end barrier member is to be located on in use.

In one embodiment one or more feet member(s) are provided on a base or base wall of the tray member and/or the barrier member which contact the surface on which the barrier system is to be located in use.

Preferably anchor engagement means or members are provided on or associated with the base anchor means or the base wall of the tray member to allow the tray member or base anchor means to be engaged with or to the surface on which the tray member or base anchor means is located on in use.

In one embodiment the anchor engagement means or members can include any or any combination of one or more bolts, pins, screws, inter-engaging members, posts, apertures, channels, through holes and/or the like.

Preferably the base wall of the base anchor means or tray member includes one or more apertures, channels, through holes and/or the like to allow anchor engagement means in the form of one or more bolts, pins, posts, screws, inter-engaging members and/or the like to be located therethrough or therewith in use.

Preferably the base wall of the base anchor means or tray member includes two or more anchor engagement means or members, further preferably three or more anchor engagement means or members, and yet preferably four or more anchor engagement means or members.

Preferably the anchor engagement means or members are provided a spaced distance apart on or in the base wall or the base anchor means or tray member, and further preferably are provided equidistance apart on or in the base wall.

Preferably the tray member includes at least three upstanding side walls.

Preferably the one or more upstanding side walls of the tray member protrude upwardly at or adjacent a peripheral edge of the base wall of the tray member.

Preferably the base wall of the tray member is entirely surrounded by three upstanding side walls and the end wall of the end barrier member.

Preferably the tray member has an opening defined by the upper free edges of the upstanding side walls.

In one embodiment one or more of the upstanding side walls of the tray member are arranged perpendicular or substantially perpendicular to the base wall of the tray member.

In one embodiment one or more of the upstanding side walls of the tray member are arranged at an acute angle with respect to the base wall of the tray member. Further preferably this acute angle is complementary or substantially complementary to the angle of one or more of the side walls of the end barrier member to which it is joined, thereby allowing the one or more tray member side walls to be flush or substantially flush with one or more of the end barrier member side walls.

In one embodiment an end housing or end cap is provided on, over or associated with the tray member to close the tray member in use. Preferably the height of the end housing or end cap is such that a top of the same is flush or substantially flush with the top of the end barrier member.

In one embodiment the end housing or end cap includes one or more protruding members which engage in one or more slots provided on the free end of the end barrier member to allow the end housing or end cap to be maintained in position in use.

In one embodiment the second or further base anchor means includes a base member with one or more anchor engagement means or members associated with the same.

Preferably the base member of the second or further base anchor means has such dimensions that it extends outwardly beyond the base of the end barrier member with which it is joined or associated with in use.

Preferably at least one end of the base member of the second or further base anchor means protrudes outwardly from the base of the end barrier member on one side of the end barrier member.

Preferably two end sections of the base member, and preferably two opposing end sections of the base member of the second or further base anchor means protrude outwardly from the base of the end barrier member on opposing sides of the end barrier member.

Preferably the anchor engagement means or members are provided on each protruding end section of the base member of the second or further base anchor means.

In one embodiment the anchor engagement means or members of the second or further base anchor means can include any or any combination of one or more bolts, pins, screws, inter-engaging members, posts, apertures, channels, through holes and/or the like.

Preferably the end sections of the base member of the second or further base anchor means includes one or more apertures, channels, through holes and/or the like to allow anchor engagement means or members in the form of any or any combination of one or more bolts, pins, posts, screws, inter-engaging members and/or the like to be located therethrough or therewith in use.

Preferably at least one end section of the base member of the second or further base anchor means, and preferably both ends sections of the base member, include two or more anchor engagement means or members.

Preferably the anchor engagement means are provided a spaced distance apart on the end section of the base member of the second or further base anchor means.

In one embodiment the base member of the second or further base anchor means is in the form of a plate member.

Preferably a longitudinal axis of the base member of the second or further base anchor means is arranged perpendicular to a longitudinal axis of the end barrier member or elongate barrier structure on which it is located in use.

In one embodiment the second base anchor means is located centrally or substantially centrally of the join between the first end barrier member and an adjacent barrier member, and/or between the second end barrier member and the adjacent barrier member.

In one embodiment the channel means is integrally formed with the barrier member, and preferably a top of the barrier member on which it is located.

In one embodiment the channel means is attached or detachably attached to the barrier member with which it is located, and preferably with a top of the barrier member.

Preferably the dimensions and/or width of the channel means is arranged such that at least part of the channel means protrudes outwardly of the barrier member from a side of the same on at least one side of the barrier member, and preferably protrudes outwardly from both sides of the barrier member. This typically creates a shoulder portion between a lower or base surface of the channel means and an outer surface of a side wall of the barrier member. This shoulder portion acts to prevent a vehicle or object impacting with the same in use from riding up or travelling up the barrier member and going over the top of the barrier member.

In one embodiment the channel means consists of or includes a U-shaped or substantially U-shaped channel member.

Preferably the channel means includes or consists of at least one channel member.

Preferably the channel means or at least one channel member includes a base wall and two upstanding side walls provided on opposite sides of the base wall.

Preferably the dimensions and/or width of the base wall of the at least one channel means or member is such that it protrudes outwardly of the top surface of the barrier member on which it is located in use on at least one side of the barrier member, and preferably both sides of the barrier member.

Thus, in one example, the width of the base wall of the channel member or channel means is wider than the width of the top or top surface of the barrier member on which it is located in use.

Preferably the uppermost free edges of the upstanding side walls of the channel means or member define an opening to the at least one channel member or channel means.

In one embodiment the upper free edges of the upstanding side walls of the at least channel member or channel means are provided with an inwardly protruding lip, flange, member and/or the like. This prevents any sharp edges from being exposed from the top of the barrier system in the event a person of vehicle lands on the same following an impact or accident.

In one embodiment a closure member is provided over or associated with the opening of the at least one channel member or channel means to close the opening. In this example, the channel of the channel means is enclosed or substantially enclosed in use. The closure member can be integral with the channel means, attached or detachably attached thereto.

Preferably the channel means or the at least one channel member is an elongate member.

Preferably a longitudinal axis of the channel means or the at least one channel member is parallel to a longitudinal axis of the barrier means on which it is located or associated with in use.

In one embodiment one or more, or both, of the upstanding side walls of the channel member or channel means are perpendicular or substantially perpendicular to the base wall of the channel member or channel means.

In one embodiment one or more, or both, of the upstanding side walls of the channel member or channel means are located at an acute angle or an obtuse angle with respect to the base wall of the channel member or channel means. Thus, the channel means or member can have outwardly diverging side walls or inwardly converging side walls.

In one embodiment securing means or members are provided on or associated with the channel means, at least one channel member and/or barrier member to allow the channel means or at least one channel member to be secured to the barrier member or to a top or top surface of the barrier member in use.

In one embodiment the securing means can include any or any combination of one or more apertures, slots, through holes, channels, screws, nuts and bolts, inter-engaging members, clips, welding, adhesive and/or the like.

Preferably the channel means are arranged in an end to end manner on the top of the barrier members in use.

In one embodiment joining means or one or more joining members are provided to allow joining together of two adjacent channel means or channel members in use.

Preferably the joining means or one or more joining members can be provided on or associated with an exterior and/or interior surface of the base wall and/or one or more side walls of a channel means or channel member.

Preferably the joining means or one or more joining members can include any or any combination of one or more plate members, joining members, nuts and bolts, screws, clips, inter-engaging members, welding, adhesive and/or the like.

In one embodiment a length of a channel member is equal to or substantially equal to a length of a barrier member on which it is to be associated with in use.

In one embodiment a length of the channel member is less than the length of a barrier member on which it is to be associated with in use. In this embodiment, two or more channel member can be provided on or associated with a top of the barrier member in use.

In one embodiment one or more end channel sections are provided with or associated with one or more ends, and preferably both ends of channel means.

Preferably the one or more end channel sections have a sloping or narrowing tapered top surface.

Preferably the sloping or tapered top surface slopes from an upper free edge of the adjacent channel means or channel member to or towards a top surface of a barrier member on which the end channel section is located.

Preferably the one or more end channel sections are enclosed or substantially enclosed. For example, they can include one or more side walls and at least a top surface, and optionally a base surface.

Preferably an end channel section is provided on the first or second end barrier members adjacent the channel means provided on or associated with the adjacent pair of barrier members.

Preferably an end channel section is provided on a barrier member adjacent each end of the pair of barrier members having the channel means provided on or associated with the same.

Preferably a length of the end channel section is less than half the length of a barrier member or the first or second end barrier members, and preferably is less than a quarter of the length of a barrier member or the first or second end barrier members.

Preferably a longitudinal axis of the end section is provided parallel or substantially parallel to a longitudinal axis of the barrier member.

According to a second aspect of the present invention there is provided a method of using a barrier system, said method including the steps of arranging a plurality of barrier members in an end to end manner to form an elongate barrier structure, a first end barrier member located at a first end of the elongate barrier structure and a second end barrier member located at a second end of the elongate barrier structure, providing base anchor means with at least an outermost end of each of the first and second end barrier members to anchor a base of the first and second end barrier members to a surface on which the barrier system is to be located in use; and wherein on a pair of barrier members consisting of two adjacent barrier members, which are not the first and second end barrier members but which are adjacent to each of the same, providing channel means on, at or adjacent a top thereof; and leaving at least one barrier member adjacent said barrier member pairs which is not the first and second end barrier members without channel means on, at or adjacent a top thereof.

### BRIEF DESCRIPTION OF THE DRAWINGS

FIGS. 1a-1c (PRIOR ART) show examples of different conventional barrier systems;

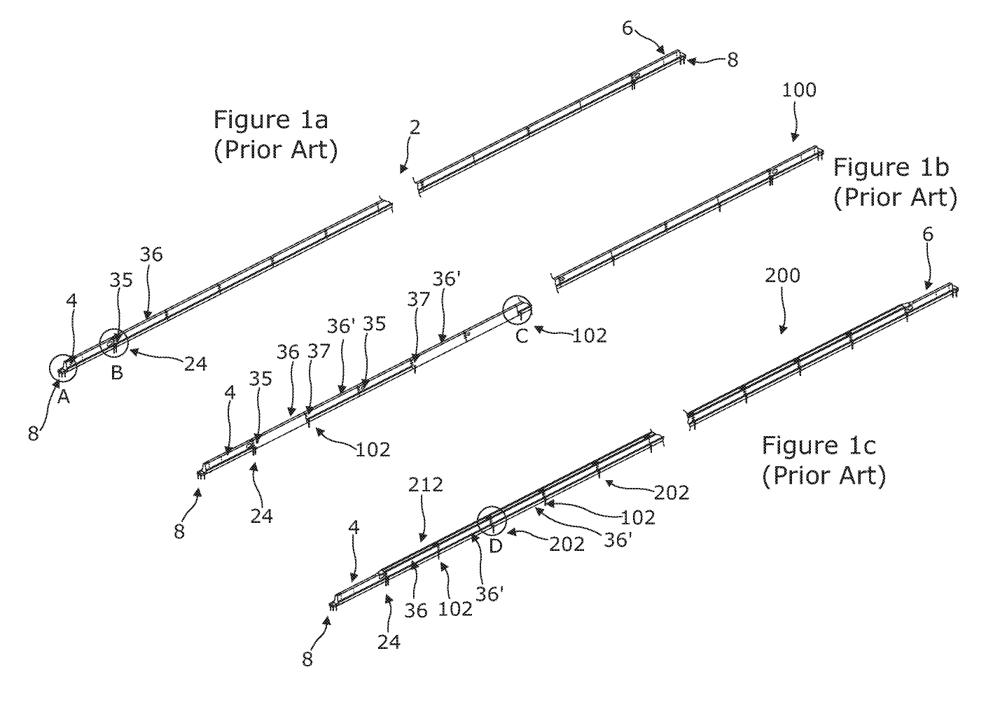

FIGS. 2a-2d (PRIOR ART) show examples of different base anchor means that can be used to anchor the barrier systems shown in FIGS. 1a-1c;

FIG. 3 is a perspective view of a barrier system according to an embodiment of the present invention;

FIG. 4 is an enlarged view of the detail ‘F’ in FIG. 3;

FIG. 5 is an enlarged view of the detail ‘G’ in FIG. 4;

FIG. 6 is a top plan view of the barrier system in FIG. 3;

FIG. 7 is an enlarged view of the detail ‘H’ in FIG. 6;

FIG. 8 is an enlarged view of the detail ‘I’ in FIG. 7;

FIG. 9 is a side view of the barrier system in FIG. 3;

FIG. 10 is an enlarged view of the detail ‘A’ in FIG. 9;

FIG. 11 is an enlarged view of the detail ‘B’ in FIG. 10;

FIG. 12 is a cross sectional view taken along line D-D in FIG. 9;

FIG. 13 is a cross sectional view taken along line E-E in FIG. 9; and

FIG. 14 is an end view of the barrier system in FIG. 3.

### DETAILED DESCRIPTION OF THE INVENTION

The embodiments discussed herein are merely illustrative of specific manners in which to make and use the invention and are not to be interpreted as limiting the scope.

While the invention has been described with a certain degree of particularity, it is to be noted that many modifications may be made in the details of the invention's construction and the arrangement of its components without departing from the scope of this disclosure. It is understood that the invention is not limited to the embodiments set forth herein for purposes of exemplification.

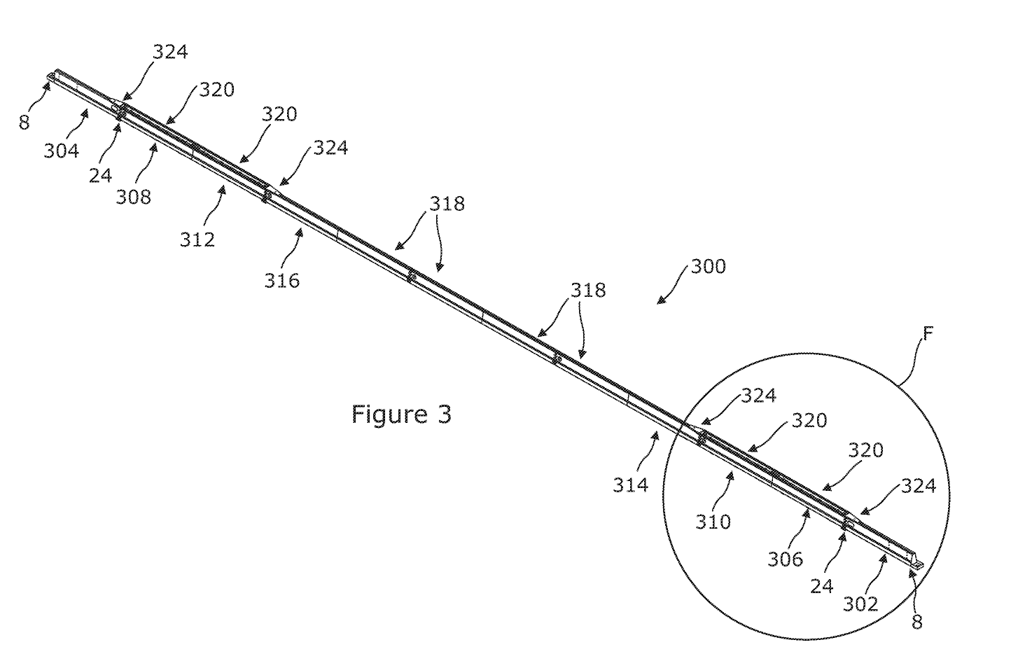

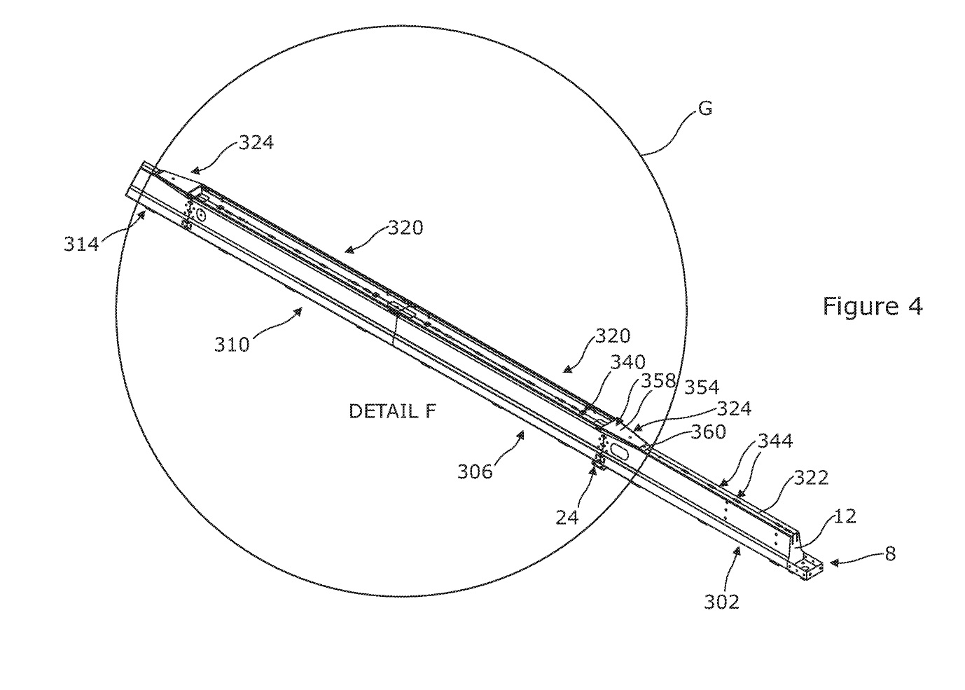

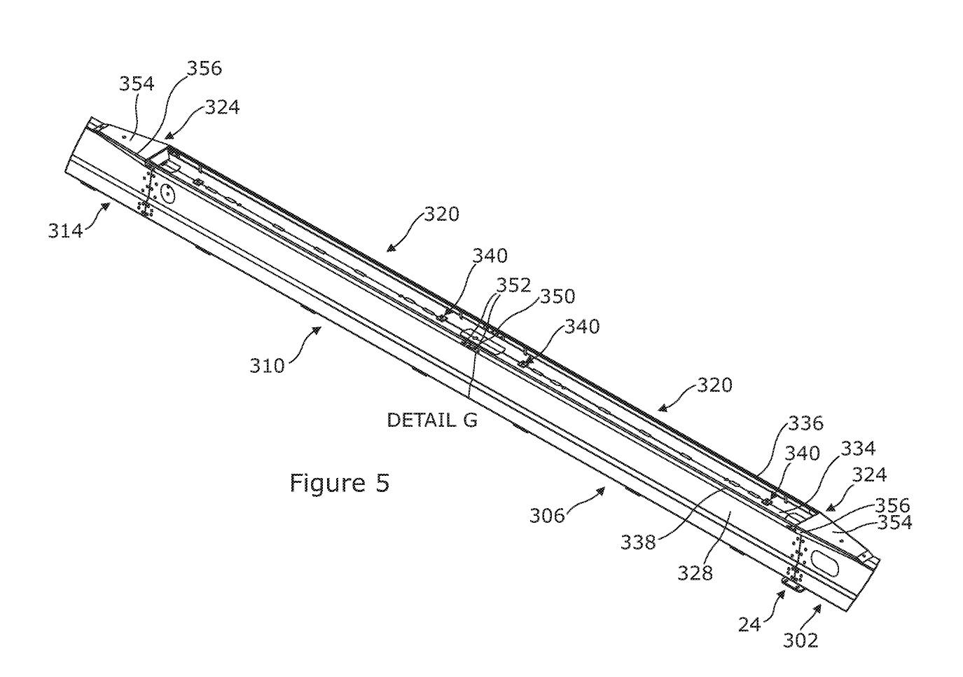

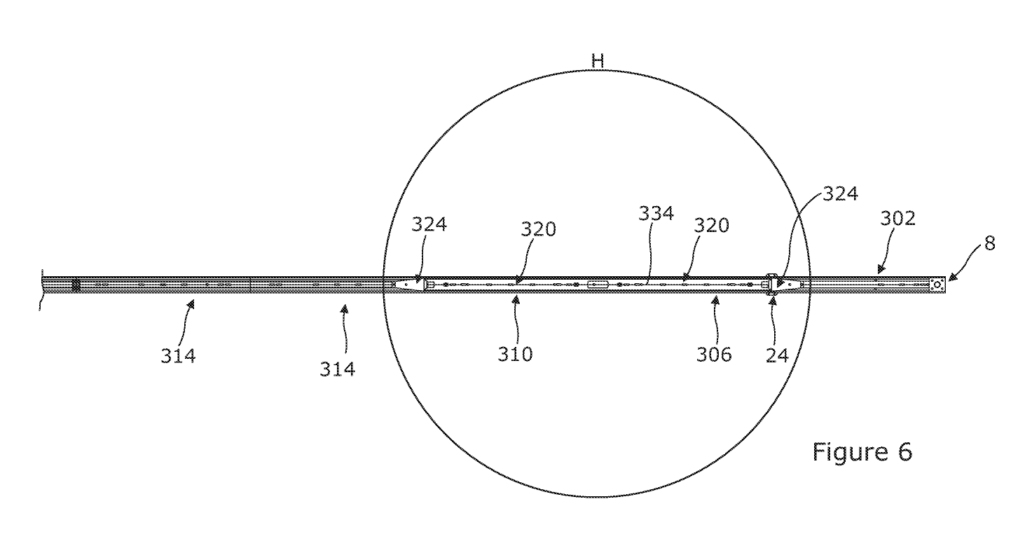

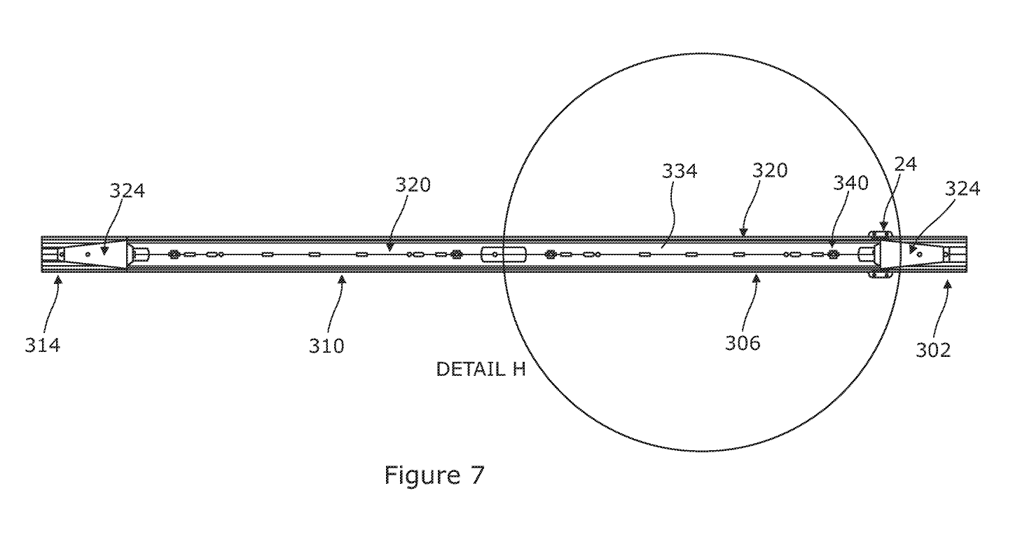

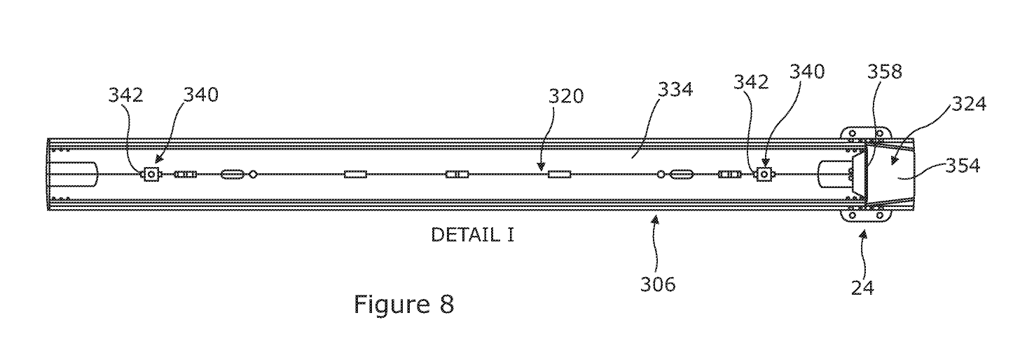

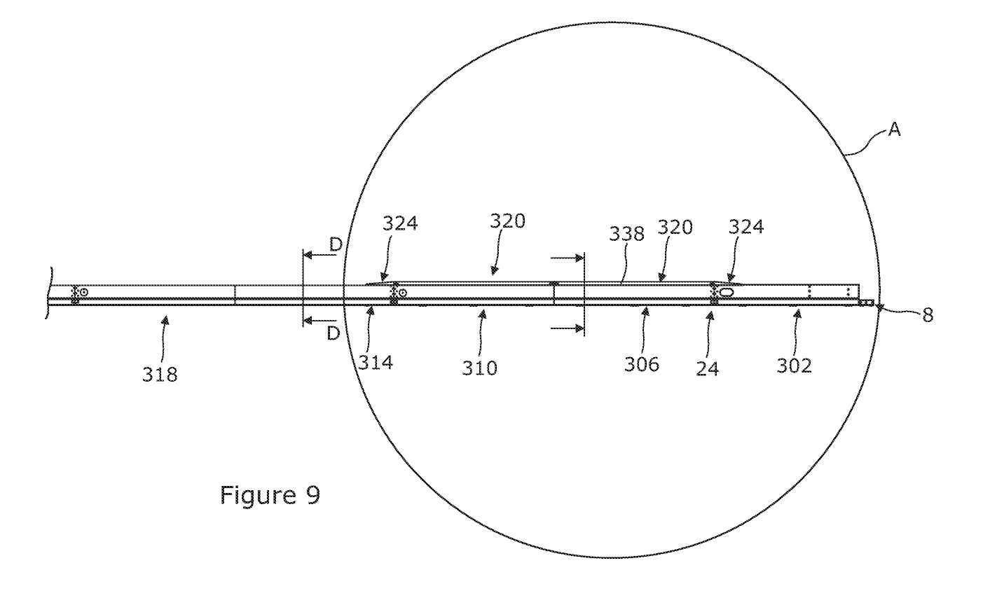

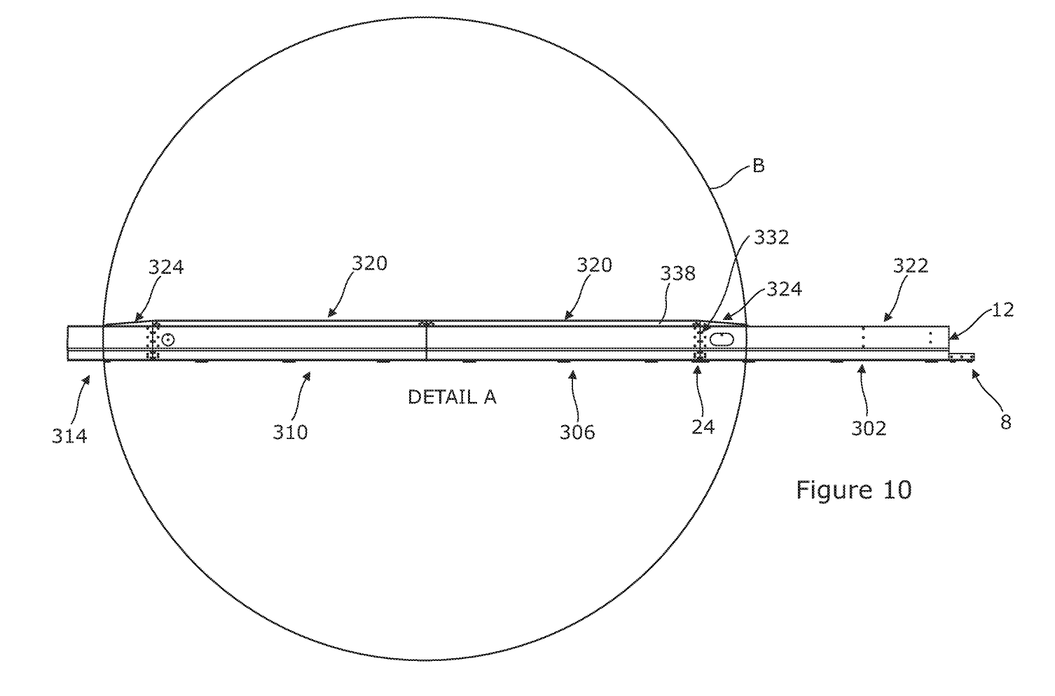

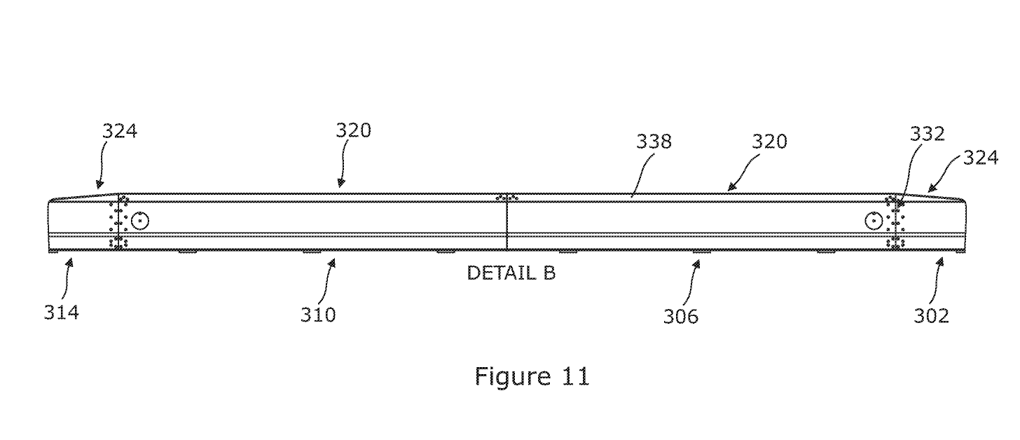

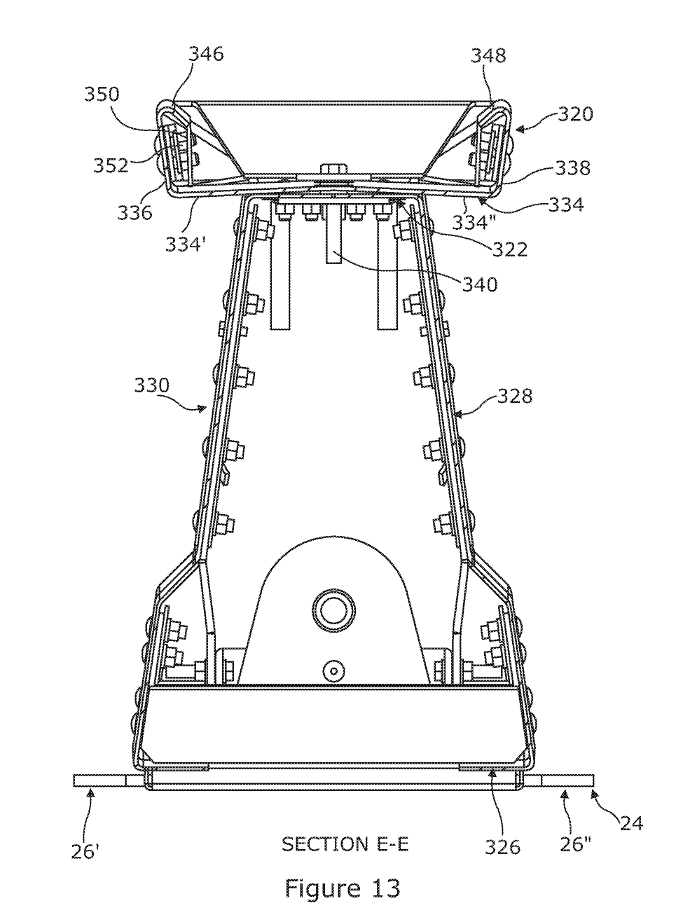

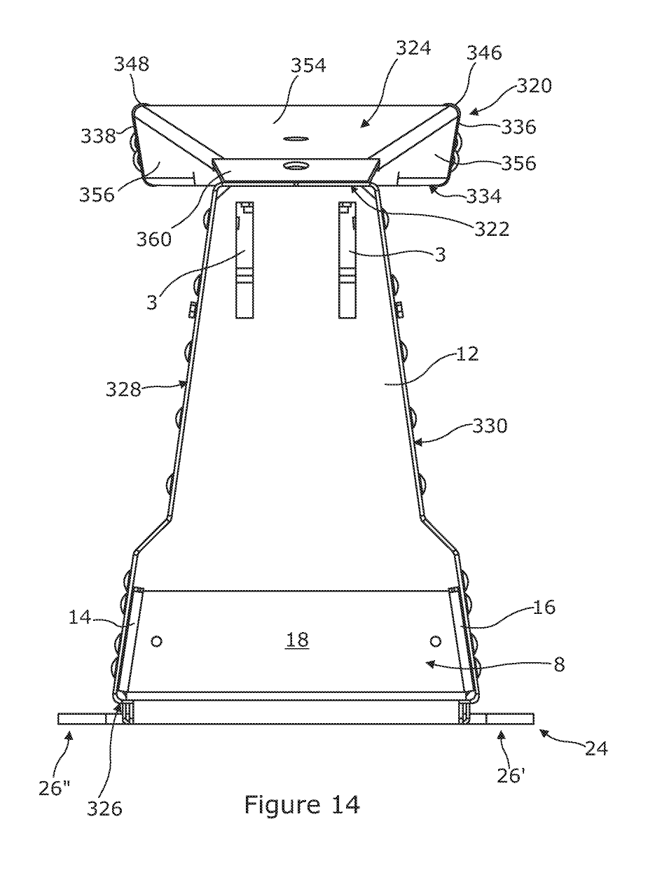

Referring to FIGS. 3 through 14, there is illustrated a barrier system 300 according to an embodiment of the present invention. The barrier system 300 comprises a plurality of individual barrier members joined together in an end to end manner.

In particular, barrier system 300 comprises a first end barrier member 302 and a second end barrier member 304. A third barrier member 306 is provided adjacent to first end barrier member 302 and a fourth barrier member 308 is provided adjacent to second end barrier member 304. A fifth barrier member 310 is provided adjacent to third barrier member 306 and a sixth barrier member 312 is provided adjacent to fourth barrier member 308. A seventh barrier member 314 is provided adjacent to fifth barrier member 310 and an eighth barrier member 316 is provided adjacent to sixth barrier member 312. Remaining barrier members 318 are provided in between seventh barrier member 314 and eight barrier member 316.

Although the following description refers to the barrier members 302-316 being individual barrier members, two or more of the barrier members can be pre-joined together during or post manufacture to form a length of barrier members so as to reduce the time taken to connect adjacent barriers in an end to end manner on site at which the barrier system is to be constructed. For example, a length of two barrier member could be provided having a mortise and tenon connection at each end of the length and a bolted joint provided in the join between the two barrier members forming the length.

In accordance with the present invention, the first and second end barrier members 302, 304 are both provided with first and second base anchor means at the free end and the end joining to an adjacent barrier member 306, 308 respectively (i.e. at the first bolted joint of the barrier system).

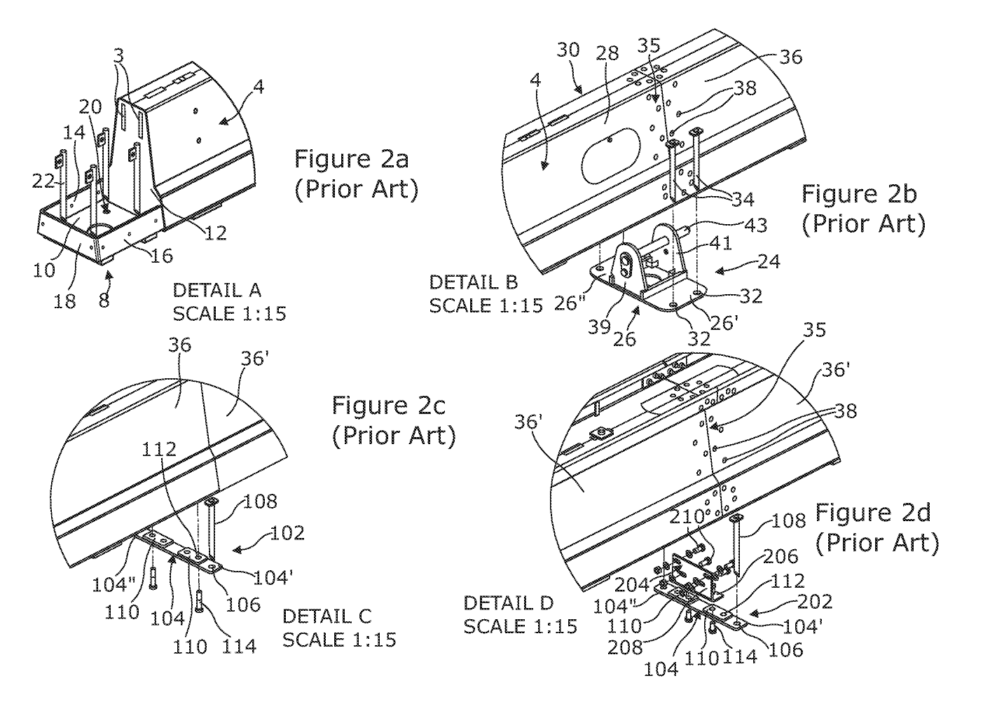

The first base anchor means in this example is an anchor tray 8, as previously described with reference to FIG. 2a. The second base anchor is a four point anchor plate 24, as previously described with reference to FIG. 2b. No other base anchor means are provided on the barrier system 300. It will be appreciated that different base anchors could be provided at the ends of the first and second end barrier members if required.

Channel means in the form of two channel members 320 are provided on a top surface 322 of the third and fifth barrier members (forming a barrier member pair) 306, 310, and on a top surface 322 of the fourth and sixth barrier members (forming a barrier member pair) 308, 312. Channel end sections 324 are joined to the ends of the channel members 320 and are located on the first and seventh barrier member 302, 314 and on the second and eight barrier members 304, 316 respectively.

Each of the barrier members 302-318 of the system is similar or the same in form and comprises a base surface 326, two upstanding and opposing side walls 328, 330, a top surface 322, and end wall 12 and an opposing end wall 332.

Each channel member 320 comprises a base wall 334 and two opposing side walls 336, 338 protruding upwardly from the edges of base wall 334, thereby forming a U-shaped channel. The channel members 320 are often referred to as T-Top members and it is to be noted that the channel members could be enclosed if required and/or could be integrally formed with the barrier members if required. Securing means in the form of a plurality of nuts and bolts 340 are provide which are located through slots 342 defined in base wall 334 and slots 344 defined in top surface 322 of the barrier members to allow the channel member 320 to be joined to the same in use.

The base wall 334 of the channel member 320 is of a width that is greater than the width of the top surface 322 of the barrier members 302-318 such that portions of base wall 334′, 334″ protrude outwardly from top surface 322 on both sides thereof. This creates a shoulder portion between the base wall portions 334′, 334″ and the barrier side walls 330, 328 respectively. The shoulder portion is used to prevent the vehicle or an object from riding too far up the barrier member following impact of the vehicle or object with the barrier member in use and to retain the vehicle or object on one side of the barrier member.

The top free edges 346, 348 of the side walls 336, 338 include an inwardly protruding flange so as to prevent any sharp edges from being exposed at the top of the barrier member.

In accordance with the present invention in one embodiment, the channel members 320 are only provided on the third and fifth barrier members 306, 310 and the fourth and sixth barrier members 308, 312 (i.e. the two barrier members forming a barrier member pair adjacent the end barrier members of the barrier system) of the barrier system. The two adjacent channel members 320 at each end of the barrier system are arranged in an end to end manner with channel end sections 324 provided at each end of the pair of channel members. The abutting ends of the channel members 320 are joined together via joining means in the form of a joining plate 350 located on an inwardly facing surface of the side walls 336, 338 which overlaps with the side walls of the two adjacent channel member side walls. Nuts and bolts 352 are located through apertures provided in the joining plate and through apertures defined in the side walls of the channel member side walls 336, 338.

In the illustration, each channel member 320 is the same length as the barrier member 306, 310 on which it is located. A longitudinal axis of the channel member 320 is parallel to a longitudinal axis of the barrier members 306, 310. Thus, in one example, each channel member is 6 m long, the barrier member is 6 m long and the combined length of the two channel members is 12 m long, spanning two barrier members.

Each channel end section 324 includes a top surface 354 and side walls 356 which have a narrowing taper from an end 358 abutting with an end of the channel member 320 to an end 360 adjacent the top surface 322 of the barrier member. The top surface 354 also has a narrowing taper from end 358 towards end 360.

The channel end sections 324 are provided on barrier members 302, 314, 304 and 316 (i.e. at either end of the barrier member pairs having the channel members provided on the same).

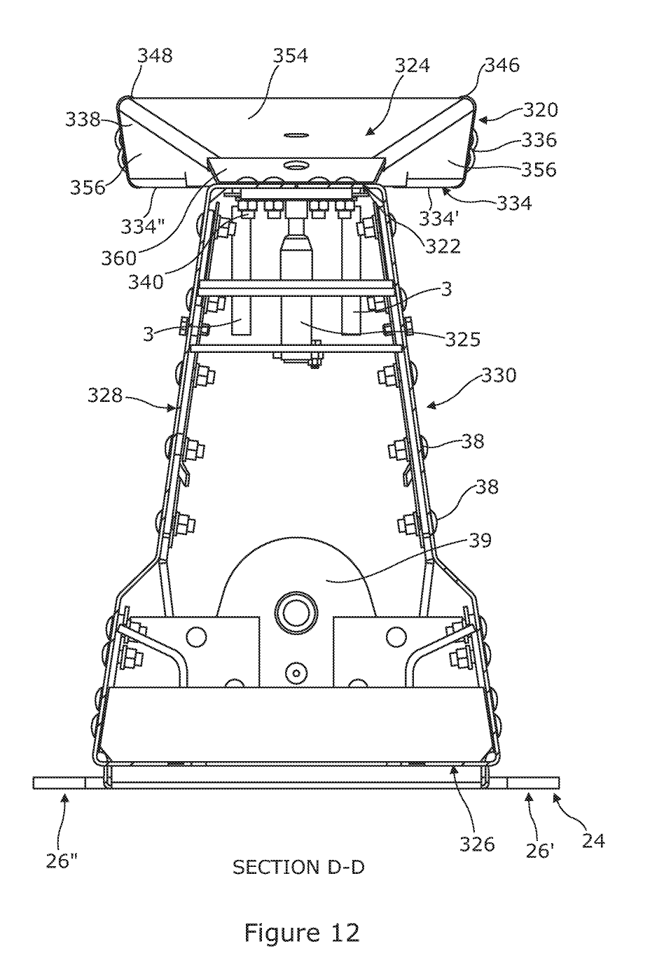

It is to be noted that FIG. 12 shows part of a mortise and tenon arrangement 325 used to join together two adjacent barrier members at one end thereof.

What is claimed is:

1. A barrier system, said barrier system including a plurality of barrier members arranged in an end to end manner to form an elongate barrier structure, a first end barrier member located at a first end of the elongate barrier structure and a second end barrier member located at a second end of the elongate barrier structure, each of the first and second end barrier members having base anchor means provided or associated with at least an outermost end thereof to anchor a base of the first and second end barrier members to a surface on which the barrier system is to be located in use, and wherein a pair of barrier members consisting of two adjacent barrier members, which are not the first and second end barrier members but which are adjacent to each of the same, are provided with channel means located on, at or adjacent at a top thereof, and at least one barrier member adjacent said barrier member pairs which is not the first and second end barrier members is not provided with channel means on, at or adjacent a top thereof.

2. The barrier system of claim 1 wherein the channel means are only provided on each pair of barrier members directly adjacent the first and second end barrier members.

3. The barrier system of claim 1 wherein the channel means are provided on each pair of barrier members directly adjacent the first and second end barrier members, plus one further pair of barrier members only.

4. The barrier system of claim 3 wherein the one further pair of barrier members is located centrally or substantially centrally of the barrier system or elongate barrier structure.

5. The barrier system of claim 1 wherein a join between each of the first and second end barrier members and an adjacent barrier member is provided with or is associated with a further or second base anchor means at a base of the barrier member(s).

6. The barrier system of claim 1 wherein a join or a first inboard bolted joint between each of the first and second end barrier members and an adjacent barrier member is joined by one or more joining members or joining plates.

7. The barrier system of claim 1 wherein each barrier member of the system, at least between the first and second end barrier members, consists of a first connection end and a second connection end; the first connection end having connection means in the form of a mortise and tenon connection, and the second connection end having connection means in the form of a mortise and tenon or a joining member, joining plate and/or a bolted joint.

8. The barrier system of claim 1 wherein the base anchor means includes a tray member having a base wall that is arranged to be flush or substantially flush with a base of an end barrier member, and one or more upstanding side walls associated with the base wall.

9. The barrier system of claim 8 wherein anchor engagement means or members are provided on or associated with the base anchor means to allow the same to be anchored to the surface in use, said anchor engagement means including any or any combination of one or more bolts, pins, screws, inter-engaging members, posts, apertures, channels or through holes.

10. The barrier system of claim 8 wherein an end housing or end cap is provided on, over or associated with the tray member to close the tray member in use.

11. The barrier system of claim 5 wherein the second or further base anchor means includes a base member with one or more anchor engagement means or members associated with the same.

12. The barrier system of claim 11 wherein the base member has such dimensions that it extends outwardly beyond the base of the end barrier member with which it is joined or associated with in use.

13. The barrier system of claim 1 wherein the dimensions or width of the channel means is arranged such that at least part of the channel means protrudes outwardly from at least one side of the barrier member, thereby creating a shoulder portion between a lower or base surface of the channel means and an outer surface of the side wall of the barrier member.

14. The barrier system or claim 1 wherein the channel means consists of or includes a U-shaped or substantially U-shaped member and/or includes a base wall and two upstanding side walls provided on opposite sides of the base wall.

15. The barrier system of claim 14 wherein the upstanding side walls each have an uppermost free edge defining an opening to the at least one channel means, and wherein said free edges are provided with an inwardly protruding lip, flange or member.

16. The barrier system of claim 14 wherein the upstanding side walls each have an uppermost free edge defining an opening to the at least one channel means, and wherein a closure member is provided over or associated with the opening to close the opening in use.

17. The barrier system of claim 1 wherein securing means or members are provided on or associated with the channel means to allow the channel means to be secured to the barrier member or to a top or top surface of the barrier member in use.

18. The barrier system of claim 1 wherein joining means or one or more joining members are provided to allow joining together of two adjacent channel means or members in use.

19. The barrier system of claim 1 wherein end channel sections are provided with or associated with one or both ends of the channel means in use.

20. A method of using a barrier system, said method including the steps of arranging a plurality of barrier members in an end to end manner to form an elongate barrier structure, a first end barrier member located at a first end of the elongate barrier structure and a second end barrier member located at a second end of the elongate barrier structure, providing base anchor means with at least an outermost end of each of the first and second end barrier members to anchor a base of the first and second end barrier members to a surface on which the barrier system is to be located in use; and wherein on a pair of barrier members consisting of two adjacent barrier members, which are not the first and second end barrier members but which are adjacent to each of the same, providing channel means on, at or adjacent a top thereof; and leaving at least one barrier member adjacent said barrier member pairs which is not the first and second end barrier members without channel means on, at or adjacent a top thereof.
